(19) United States
(12) Patent Application Publication
(10) Pub. No.: US 2014/0123641 A1
(43) Pub. Date: May 8, 2014

(54) WAVE ENERGY CONVERTER COMPRISING VORTEX TRAIL-GUIDING DEVICE AND METHOD FOR CONVERTING WAVE ENERGY

(71) Applicant: Robert Bosch GmbH, Stuttgart (DE)

(72) Inventors: Nik Scharmann, Bietigheim-Bissingen (DE); Benjamin Hagemann, Norderstedt (DE); Jasper Behrendt, Hamburg (DE); Alexander Poddey, Wiernsheim (DE)

(73) Assignee: Robert Bosch GmbH, Stuttgart (DE)

(21) Appl. No.: 14/071,709

(22) Filed: Nov. 5, 2013

(30) Foreign Application Priority Data
Nov. 6, 2012 (DE) 10 2012 021 620.3

(51) Int. Cl. F03B 13/14

(52) U.S. Cl. CPC F03B 13/14
USPC 60/495; 416/1

(57) ABSTRACT

A wave energy converter includes at least one rotor which is configured to convert a wave motion of an agitated body of water into a rotational motion of the at least one rotor. The at least one rotor has at least two elongate lift profiles which are each connected by one end to a rotor base. The lift profiles are each connected in pairs to one another via at least one vortex trail-guiding device in a region of their free ends, not connected to the rotor base, of the lift profiles.

This application claims priority under 35 U.S.C. §119 to patent application no. DE 10 2012 021 620.3, filed on Nov. 6, 2012 in Germany, the disclosure of which is incorporated herein by reference in its entirety.

### BACKGROUND

The present disclosure relates to a wave energy converter having at least one rotor which is configured to convert a wave motion into a rotational motion of the at least one rotor, and to a method for converting wave energy in which such a wave energy converter is used.

A series of different devices are known for converting energy from movements of water in bodies of water into usable energy. An overview of this is given, for example, by G. Boyle, “Renewable Energy”, 2^{nd} edition, Oxford University Press, Oxford 2004. Such devices are also referred to as “wave energy converters”.

In wave energy converters, the energy can be extracted from the respective water motion in different ways. For example, buoys which float on the surface of the water and whose upward and downward movements drive a linear generator are known. A planar resistance element, which is tilted to and from by the motion of the water, can also be mounted at the bottom of the body of water. The kinetic energy is, for example, converted into electrical energy in a generator.

Within the scope of the present disclosure, in particular wave energy converters are of interest which are arranged with their moving parts under the surface of the water and which utilize a wave orbital motion which is present there.

The wave orbital motion can be converted into a rotational motion by means of rotors. For this purpose, rotors with coupling bodies, for example hydrodynamic lift profiles, can be used. Such a system is disclosed in US 2010/0150716 A1.

As in all hydrodynamic lift profiles with a finite length, eddying which is induced by the pressure differences between the pressure side and the suction side also occur here at the ends of the lift profiles, said eddying also being known as vortex trails. These can considerably limit the efficiency.

From aircraft construction, it is known to use elliptical lift profiles which reduce the formation of vortex trails to a certain extent. Alternatively, closed profile systems can also be used in which the ends of the lift profiles are curved and correspondingly joined together (referred to as looped wings). Such profiles are, however, costly to fabricate. What are referred to as winglets at the ends of the lift profiles can be used as the smallest expansion level, but said winglets have to be adapted to the respective prevailing flow conditions. In avionics, winglets are therefore always adapted to the profile of the journey (short distance/long distance).

In wave energy converters, in particular in those with rotating lift profiles, there continues to be a need for corresponding improvements.

### SUMMARY

According to the disclosure, a wave energy converter having at least one rotor which is configured to convert a wave motion into a rotational motion of the at least one rotor, and a method for converting wave energy in which such a wave energy converter is used, are proposed. Advantageous refinements are a subject matter of the following description.

The present disclosure is based on the recognition that in wave energy converters, in particular in those with rotating lift profiles, vortex trails do not necessarily have to be avoided but instead can even be used in a way which is beneficial to operation. As a result, it is possible to increase the efficiency.

In a wave energy converter which is proposed according to the disclosure and which has at least one rotor which is configured to convert a wave motion into a rotational motion of the at least one rotor, at least two elongate lift profiles are connected by in each case one end to a rotor base and are each connected in pairs to one another via vortex trail-guiding devices in the region of their free ends (or at their free ends) which are not connected to the rotor base.

Two lift profiles are advantageously arranged offset through 180° on the rotor of a wave energy converter according to the disclosure. In this context, the orientation of the two lift profiles is preferably such that in one lift profile the suction side is oriented radially toward the inside and in the other lift profile it is oriented radially toward the outside. In the two lift profiles, the lift is therefore basically oriented in one direction. The suction side, and therefore the direction of the lift, occur as a result of the shape of the lift profiles and the incoming flow onto the body of water, as explained below.

As a result, the respective rotation of the vortex trails of the lift profiles has an opposing orientation, as illustrated in detail with reference to FIG. 4. Since both lift profiles also circulate about a rotor axis on a circular path defined by a rotor base and/or corresponding lever arms, one lift profile therefore impacts in each case on the vortex trail of the other lift profile with a respective opposite direction of rotation. The vortex trail systems of the two lift profiles, whose rotation is oriented in opposite directions, advantageously influence one another here in a positive fashion, with the result that the influence of the resistance which is conventionally induced by the lift profiles can be significantly attenuated or eliminated. This effect is based on the principle of the conservation of energy, i.e. vortices which are directed in opposite directions cancel one another out. If the dissipation of energy of the vortex trails or of the peripheral vortices which cause them as a result of viscous effects of the fluid is ignored, and therefore the energy of the vortex trails or peripheral vortices remains constant over time on a circular path on which they subsequently impact on the following lift profile, there is no need for any additional power or energy for the further generation of corresponding vortices (by the following lift profile). As a result, the induced resistance also disappears. So that this effect can occur, it is necessary to ensure that the vortex trails or peripheral vortices remain on the corresponding circular path and are not expelled into the surrounding fluid. This is ensured by the vortex trail-guiding devices according to the disclosure. If more than two lift profiles are used, all lift profiles are connected to one another in pairs by means of corresponding vortex trail-guiding devices. As long as the vortex field formed by the vortex trails is held in position and the total energy of the vortex field does not change (which is clearly true in the case of systems which have periodic timing), no losses occur as a result of the peripheral vortices (if, as mentioned, the viscosity of the fluid is ignored).

The arrangement corresponds here, when transferred to a linear motion, essentially to a concatenation of an infinite number of lift profiles, of which the pressure side and the suction side are each alternately oriented upward. A rotor which is embodied according to the disclosure therefore advantageously has an even number of lift profiles which each have suction sides which alternate with one another.

The vortex trail-guiding devices provided according to the disclosure between the free ends of the lift profiles therefore ensure here that the vortex trails are carried out of the rotor path of the blades through flow effects and/or motions of the rotor. They therefore prevent said positive canceling-out effect from being reduced or eliminated. Such “carrying out” also explicitly means here deflection toward the center of the rotor, as conventionally also occurs with wave energy converters which are not influenced by the flow.

Vortex trail-guiding devices which connect the lift profiles of a corresponding wave energy converter in each case in pairs at the devices' free ends are advantageously embodied as largely semicircular guiding elements. These run, in particular, along the aforementioned circular path which the lift profiles describe during their rotation and on which the vortex trails are also intended to circulate. They connect the respectively rear free corner of a lift profile to the corresponding front free corner of the following lift profile. The terms “at the front” and “at the rear” relate to the direction of rotation. The vortex trail-guiding devices are advantageously embodied in a flexible way in order to permit adjustment of the angles of attack of the lift profiles.

The vortex trail-guiding devices can be embodied here, for example, in a solid fashion (that is to say in the form of rod-shaped elements which are curved in accordance with the circular path). In this case they can have, for example, a round cross section. In this case, the vortices of the vortex trails advantageously run concentrically around the vortex trail-guiding devices, with the result that the vortex trails remain on the annular cross section. In another embodiment, tubular elements can also be used, for example, said tubular elements likewise being curved in accordance with the circular path and being interrupted by the lift profiles. The vortices of the vortex trails are guided here into the tubular vortex trail-guiding device, that is to say they run here in the vortex trail-guiding devices, instead of around said vortex trail-guiding devices as before. The diameter of a corresponding tubular vortex trail-guiding device should be advantageously selected to be sufficiently large here that the resistance of the flow through the tube does not become too large. Diameters of, for example, approximately 0.5 m have proven favorable here. A tubular vortex trail-guiding device can also be provided with a favorable cross-sectional geometry which facilitates initiation of the vortex trails. The respectively used material advantageously has a smooth surface or a defined degree of roughness in order to minimize friction losses. In both specified embodiments, the cross-sectional shape is advantageously constant over the length of the element.

Even in cases in which lateral flows, lateral rotation of a wave energy converter and/or other effects occur, the vortex trail-guiding devices therefore ensure that the vortex trails run along these guiding elements.

With respect to features and advantages of the method which is also proposed according to the disclosure for converting wave energy, reference is made to the explanations above and to those below. The method according to the disclosure is particularly efficient by virtue of the use of the vortex trail-guiding device.

The disclosure and preferred refinements are explained further below with reference to the appended drawings.

### BRIEF DESCRIPTION OF THE DRAWINGS

FIG. 1 is a schematic illustration of the formation of eddying at a lift profile against which a medium flows,

FIG. 2 is a schematic illustration of wave orbital motions under the surface of an agitated body of water,

FIG. 3 shows a wave energy converter which is not according to the disclosure and which has lift profiles in a schematic illustration,

FIG. 4 shows the flow against the wave energy converter in FIG. 3 and the formation of vortex trails which occurs at a result, and

FIG. 5 shows a wave energy converter according to the disclosure with lift profiles and vortex trail-guiding devices in a schematic illustration.

Identical or identically acting elements have identical reference symbols in the figures. The explanations will not be repeated.

### DETAILED DESCRIPTION

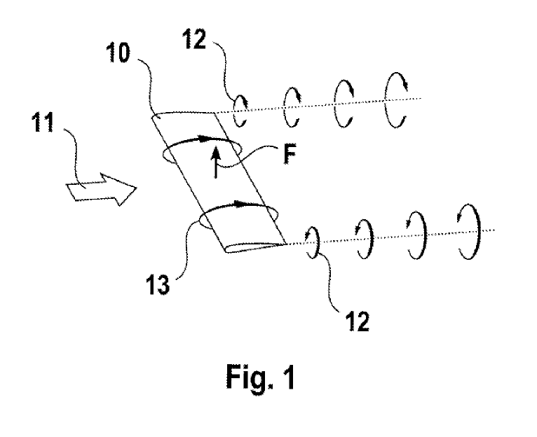

FIG. 1 shows a highly simplified diagram of the formation of eddying at a lift profile 10 against which a medium flows. The medium may be, for example, water or air. The lift profile 10 is therefore embodied as an aerodynamic or hydrodynamic lift profile.

As a result of the incoming flow, which occurs here relative to the lift profile 10 in an incoming flow direction 11, different rates occur above and below the lift profile 10, with the result that lift (directed upward here and denoted by a force vector F) occurs. Said lift “pulls” on what is referred to as a suction side (here the upper side) of the lift profile 10. The opposite side (here the underside) is also referred to as the pressure side of the lift profile 10.

The lift profile 10 has a finite length, with the result that the eddying already mentioned occurs at its ends. The ends of the lift profile 10 continue here parallel to the incoming flow direction in virtual projection lines (represented by dashes). Owing to the different flow rates above and below the lift profile, vortex trails are formed, illustrated here schematically in the form of vortices 12. The latter are provided only partially with reference symbols.

The motion of the medium brings about here in each case a rotation of the medium in a direction from below to above the lift profile 10, that is to say from the pressure side to the suction side of the lift profile 10, downstream thereof (viewed from the direction of the incoming flow). The vortex trails therefore represent rotating rollers which extend rearward from the ends of the lift profile 10. The latter are illustrated in idealized form in FIG. 1. In reality they do not run parallel to the projection lines (represented by dashes). In the case of aircraft, the vortex trails diverge, for example, outward from the axis of the aircraft and are additionally inclined downward in the direction of the surface of the earth. The diameters of the vortex trails, that is to say the radii of the vortices 12, generally increase with the distance from the lift profile 10. In addition to the free vortices 12, which give rise to the vortex trails, under certain circumstances what are referred to as bound vortices 13 can also be observed, but they play a minor role within the scope of the present disclosure.

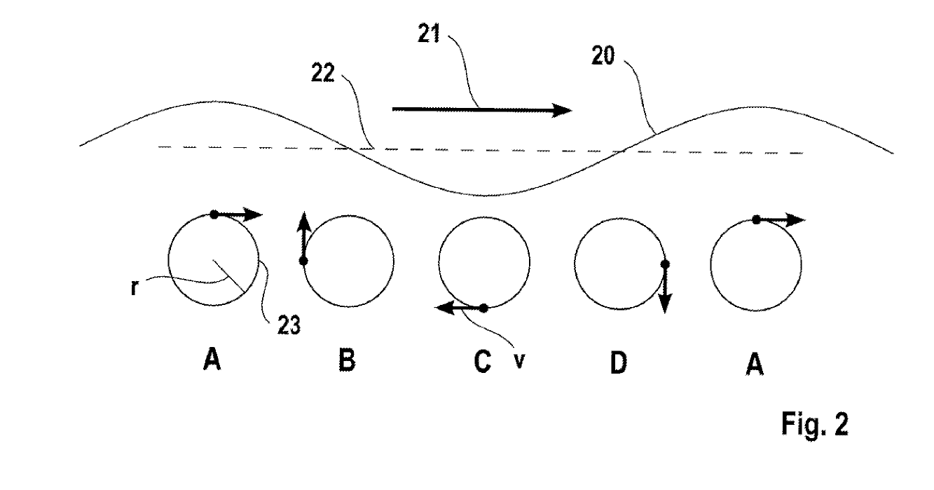

FIG. 2 shows a schematic illustration of wave orbital motions under the surface of an agitated body of water. A wave on the surface of the body of water is denoted by 20. A wave crest is located at a position A, and a wave valley at a position C. The wave propagates in a direction 21 of propagation. At the positions B and D there are the transitions between the wave crest/wave valley and wave valley/wave crest. The central surface of the body of water is denoted by 22.

Owing to the wave motion, wave orbital motions in the form of orbital paths 23, which are provided only partially with reference symbols, occur under the surface of the body of water. Directly under this surface of the body of water, these orbital paths 23 each have radii r which correspond to the amplitude of the wave 20. The radii reduce as the distance from the surface of the body of water increases. In deep water the orbital paths 23 are circular, and in shallow water they are increasingly elliptical.

The local motion of the water is illustrated in FIG. 2 in each case in the form of short bold arrows which correspond to the respective motion vectors v. Under a wave crest at position A, the totality of the water particles move here in the direction 21 of propagation of the waves. Under a wave valley at position C, the totality of the water particles move counter to the direction of propagation of the waves. At the transition from a wave crest (position A) to a wave valley (position C), specifically progressing in the direction of propagation of the waves, at position B a situation occurs in which the totality of the water particles move perpendicularly upward. Conversely, at the transition from a wave valley (position C) to a wave crest (position A), again progressing in the direction 21 of propagation of the waves, the totality of the water particles move perpendicularly downward. Overall, this results in a continuous change in the incoming direction of flow at a fixed position, the rotational speed of which change corresponds to the wave frequency.

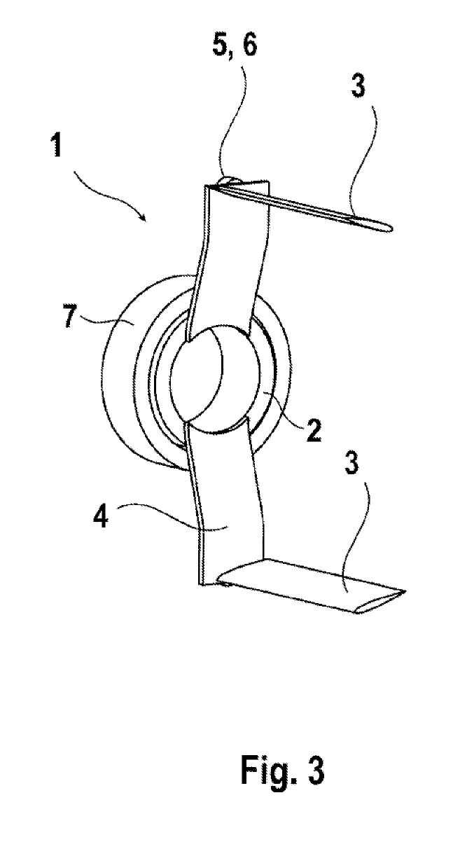

FIG. 3 shows a wave energy converter which is not according to the disclosure and which can make use of such wave orbital motion. The wave energy converter is denoted in total by 1. It has a rotor 2, 3, 4 with a rotor base 2 on which elongate lift profiles 3 are mounted by means of rotor arms or lever arms 4. The lift profiles 3 are connected by one end to the lever arms 4 and can be rotated via, for example, adjustment devices 5 at an angle (referred to as pitch angle) about their longitudinal axis. The adjustment devices 5 can be assigned position sensors 6 for this purpose.

The lift profiles 3 are arranged at an angle of 180° with respect to one another in relation to the axis of the rotor 2, 3, 4. The lift profiles 3 are preferably connected to the lever arms 4 in the vicinity of their pressure point in order to reduce rotational moments on the lift profiles 3 during operation, and therefore to reduce the requirements made of the securing means and/or the adjustment devices.

The radial distance between a suspension point of a lift profile 3 and the rotor axis is 1 m to 50 m, preferably 2 m to 40 m and particularly preferably 6 m to 30 m. The chord length of the lift profiles 3 is, for example, 1 m to 8 m. The maximum extent of length can be, for example, 6 m or more.

The wave energy converter 1 has an integrated generator. In this context, the rotor base 2 is rotatably mounted in a generator housing 7. The rotor base 2 forms the rotor of the generator, and the generator housing 7 forms the stator of said generator. The necessary electrical devices such as coils and lines are not illustrated. In this way, a rotational motion of the rotor base 2 which is induced by the wave orbital motion can be converted with the lift profiles 3 mounted thereon via the lever arms 4 directly into electrical energy. However, the disclosure can be used not only in such wave energy converters with an integrated generator but is also suitable for systems in which the rotational motion is applied to a generator, for example via a transmission.

Even though FIG. 3 shows a wave energy converter 1 in which the lift profiles 3 are mounted on just one side of a rotor base 2 via their lever arms 4, the disclosure can also be used in wave energy converters 1 in which lever arms 4 or lift profiles 3 are attached on both sides of the rotor base 2.

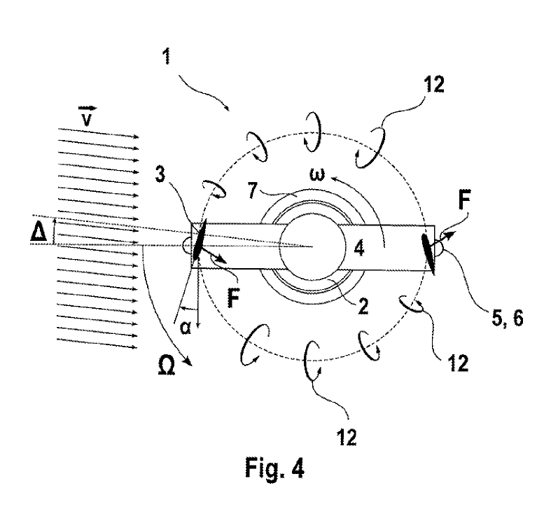

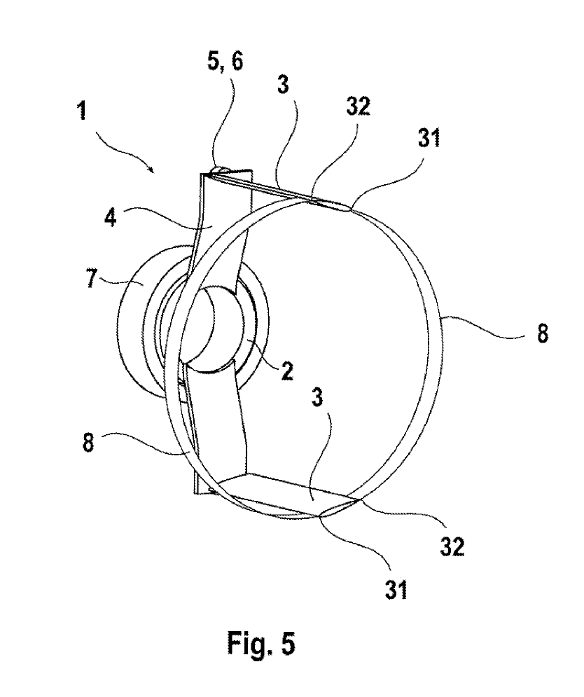

The rotor arms 4 also do not necessarily have to be embodied in the way illustrated. For example, the lift profiles 3 can also be connected to the rotor base 2 via a disk-shaped element. For the disclosure it is essential that a wave energy converter 1 has elongate lift profiles 3 which are connected by one end to a rotor base 2 and by their respective other end project freely into the body of water. As is explained below with reference to FIG. 4, this results in the formation of vortex trails at the free ends of the lift profiles 3. Said vortex trails can be used efficiently in the wave energy converter shown in FIG. 5.

In FIG. 4, the wave energy converter 1 in FIG. 3 is shown once more in a plan view of the rotor base 2. As mentioned, the wave energy converter 1 has a generator housing 7 and a rotor 2, 3, 4 which is rotatably mounted thereon and has a rotor base 2 and two coupling bodies in the form of hydrodynamic lift profiles 3 which are mounted on the rotor base 2 in a rotationally fixed fashion in each case via rotor arms 4. The lift profiles 3 project from the rear to the front into the body of water in FIG. 3.

The rotor 2, 3, 4 is arranged below the surface of the water of an agitated body of water, for example an ocean. In this context, for example deep water conditions are assumed to be present in which the orbital paths 23 of the water molecules run largely in a circular shape. A rotational axis of the rotor (perpendicular to the plane of the paper) is assumed to be oriented largely horizontally and largely perpendicularly with respect to the direction 21 of propagation of the waves 20 of the agitated body of water.

By means of the adjustment devices 5 (denoted only on the right-hand lift profile), an angle of attack or pitch angle α of the two lift profiles 3 can be set with respect to a tangent to the rotor which runs respectively perpendicularly upward or downward (shown only on the left-hand lift profile). The angles of attack a of the two lift profiles are preferably oriented opposite one another and have, for example, values of −20° to +20°. However, in particular when the wave energy converter 1 is started, it is also possible to provide larger angles of attack. For example, the angles of attack a can be adjusted independently of one another. The adjustment devices 5 may be, for example, electromotive adjustment devices, preferably with stepping motors, and/or can be hydraulic and/or pneumatic components.

The two adjustment devices 5 can, as mentioned, be assigned position sensors 6 for determining the current angles of attack a. A further sensor system (not illustrated) can determine the rotational angle of the rotor base 2 with respect to the housing 7. However, the disclosure is also suitable for systems without adjustment devices 5 for adjusting the angles of attack a or pitch angles and/or corresponding sensor systems.

The orbital flow flows against the wave energy converter 1 with an incoming flow speed [symbol] . The incoming flow here is the orbital flow of sea waves (see FIG. 2), the direction of which changes continuously with an angular speed Ω. FIG. 4 therefore shows an instantaneous recording.

In the case illustrated, the rotation of the orbital flow is oriented in the counter-clockwise direction, and the associated wave therefore propagates from right to left. In the case of so-called monochromatic waves, the incoming flow direction changes here with the angular speed Ω=2πf=const., wherein f is the frequency of the monochromatic wave. In multichromatic waves, Ω is subject to a change over time, Ω=f(t), since the frequency f is a function of the time, f=f(t). There is provision that the rotor 2, 3, 4 rotates in synchronism with the orbital flow of the wave motion with an angular speed co, wherein the term synchronicity is to be understood as chronological average.

As a result of the effect of the flow with the incoming flow speed [symbol] on the lift profiles 3, in each case lift is generated (specified in each case by the force vector F) and as a result a first torque acting on the rotor 2, 3, 4 is generated. In order to set the synchronicity, a preferably variable second torque in the form of a resistance, that is to say a braking torque, or an acceleration torque, can be applied to the rotor 2, 3, 4. Means for generating the second torque can be arranged between the rotor base 2 and the generator housing 7.

A phase angle Δ whose value can be influenced by a suitable setting of the first and/or second torque is present between the rotor orientation, which is illustrated by a lower dashed line and runs through the rotor axis and the center of the two adjustment devices 5, and the direction of the orbital flow, which is illustrated by an upper dashed line and runs through one of the speed arrows [symbol] . In this context, a phase angle from −45° to 45°, preferably from −25° to 25° and particularly preferably from −15° to 15° for generating the first torque appears particularly advantageous since here the orbital flow [symbol] and the incoming flow are oriented largely perpendicularly with respect to one another owing to the intrinsic rotation, which brings about maximization of the rotor torque.

The illustration of the lift profiles 3 in FIGS. 4 and 5 occurs only by way of example for defining the different machine parameters. It is therefore possible during operation for the angles of attack of the two lift profiles 3 also to be embodied in a way opposite that illustrated. The lift profile 3 on the left in FIG. 4 would then be adjusted inward and the lift profile 3 on the right in FIG. 4 would be adjusted outward. In this context, in contrast to this schematic illustration with uncurved symmetrical profiles, it is also possible to use other profile geometries, which can in addition also be adapted to the circular path line and/or transformed.

As a result of rotation of the rotor 2, 3, 4, vortex trails also form here at the ends of the lift profiles 3 and are illustrated again in the form of vortices 12, in a highly schematic fashion. The vortices 12 denote the vortices which form at the free ends of the lift profiles 3 which are not mounted on the lever arms 4.

Owing to the rotational motion to, the suction side of the lift profile 3 on the left in FIG. 4 lies radially on the inside at the angle of attack α (illustrated by the force vector F), and the pressure side lies radially on the outside. The suction side of the lift profile 3 which is on the right in FIG. 4 lies radially on the outside at the corresponding angle of attack α, and the pressure side lies radially on the inside. The rotational motion of the vortex trails therefore occurs in the direction of the illustrated arrow, wherein the vortex trails which are respectively produced by the two lift profiles 3 are opposed to one another in their direction of rotation.

In reality, corresponding vortex trails do not run in the plane of the paper around the center point of the rotor 2, 3, 4 but converge, for example, with respect to the axis of the rotor and/or run out of the plane of the paper. This is where the present disclosure comes in.

In this context, by means of suitable vortex trail-guiding devices between the lift profiles 3 it is ensured that the vortex trails of the respective one lift profile are deflected onto the respective following lift profile (in the direction of rotation).

Such a wave energy converter is shown in FIG. 5. Corresponding vortex trail-guiding devices are denoted by 8 here. The vortex trail-guiding devices 8 are embodied here in each case in the form of semicircular guiding elements which connect the free ends of the lift profiles 3 to one another in each case in pairs. It is clear in particular that the guiding elements each connect a free corner 31, lying at the front in a direction of rotation, of one lift profile 3 to a free corner 32, lying at the rear in the direction of rotation, of the other lift profile 3. In order also to ensure adjustability of the lift profiles 3 by means of the adjustment devices 5 here, the vortex trail-guiding devices 8 are preferably of elastic configuration.

Even though flat structures are shown as vortex trail-guiding devices 8 in FIG. 5, rod-shaped or tubular elements, for example with a round cross section, are advantageously used as vortex trail-guiding devices 8. The features and advantages of these embodiments have been explained above. The vortex trail-guiding devices 8 can be composed, for example, of metal and/or plastic.

What is claimed is:

1. A wave energy converter, comprising:
at least one rotor configured to convert a wave motion of an agitated body of water into a rotational motion of the at least one rotor, the at least one rotor having at least two elongate lift profiles which are each connected by one end to a rotor base,
wherein the at least two lift profiles are each connected in pairs to one another via at least one vortex trail-guiding device in a region of their free ends which are not connected to the rotor base.

2. The wave energy converter according to claim 1, wherein the at least two lift profiles includes two lift profiles arranged offset with respect to one another through 180° in relation to an axis of the rotor and connected to one another via two vortex trail-guiding devices.

3. The wave energy converter according to claim 1, wherein the at least two lift profiles includes an even number of four or more lift profiles distributed evenly about an axis of the rotor and connected to one another by vortex trail-guiding devices.

4. The wave energy converter according to claim 1, wherein the at least one vortex trail-guiding device is formed as a circular segment.

5. The wave energy converter according to claim 1, wherein the at least one vortex trail-guiding device is formed in solid or tubular fashion.

6. The wave energy converter according to claim 1, wherein the at least one vortex trail-guiding device connects a free corner, lying at a front in a direction of rotation, of a first lift profile to a free corner, lying at a rear in the direction of rotation, of a second lift profile in a paired fashion.

7. The wave energy converter according to one claim 1, wherein the at least one vortex trail-guiding device is formed in a flexible fashion.

8. The wave energy converter according to claim 1, wherein the at least one vortex trail-guiding device is configured to run at least partially along a circular path described by the at least two elongate lift profiles.

9. The wave energy converter according to claim 1, further comprising at least one adjustment device configured to adjust the at least two lift profiles about their longitudinal axis.

10. The wave energy converter according to claim 1, wherein the rotor base of the rotor is configured to form a rotor of a generator of the wave energy converter and is configured to rotate with respect to a generator housing.

11. The wave energy converter according to claim 1, wherein the at least two lift profiles are each connected to the rotor base of the rotor via a lever arm.

12. A method for converting wave energy, comprising:
rotating at least one rotor of at least one wave energy converter substantially in synchronism with a wave orbital motion of an agitated body of water; and
converting the rotational motion into electrical energy,
wherein the at least one rotor of the at least one wave energy converter includes at least two elongate lift profiles which are each connected by one end to a rotor base, and
wherein the at least two lift profiles are each connected in pairs to one another via at least one vortex trail-guiding device in a region of their free ends which are not connected to the rotor base.

13. The method according to claim 12, further comprising:
setting the lift profiles of the wave energy converter in such a way that vortex trails with respectively opposite directions of rotation are formed at the free ends of the lift profiles,
wherein the vortex trails are each guided with a vortex trail-guiding device from one lift profile to a lift profile which follows in a direction of rotation.

14. The wave energy converter according to claim 5, wherein the at least one vortex trail-guiding device is formed with a circular cross section.

15. The method according to claim 13, wherein the lift profiles are set with an adjustment device.
